(19) United States
(12) Patent Application Publication
(10) Pub. No.: US 2015/0214515 A1
(43) Pub. Date: Jul. 30, 2015

(54) PACKAGING FILM FOR BATTERY

(71) Applicant: BenQ Materials Corporation, Taoyuan County (TW)

(72) Inventors: Kuan-Kuo LAI, Taoyuan County (TW); Shau-Tai LU, Taoyuan County (TW)

(21) Appl. No.: 14/557,471

(22) Filed: Dec. 2, 2014

(30) Foreign Application Priority Data
Jan. 29, 2014 (TW) 103103615

(51) Int. Cl. H01M 2/02; H01M 2/08

(52) U.S. Cl. CPC H01M 2/0287; H01M 2/08

(57) ABSTRACT

A packaging film for a battery and a method for manufacturing the same are provided. The packaging film includes an aluminum foil layer, a fluorine resin layer, an adhesive layer and a polyolefin sealant layer. The fluorine resin layer is disposed on a surface of the aluminum foil layer. The adhesive layer is disposed on another surface of the aluminum foil layer opposite to the fluorine resin layer. The polyolefin sealant layer is attached on the aluminum foil layer by the adhesive layer. The packaging film for the battery of the present invention has thinner thickness and provides better weatherability.

### RELATED APPLICATIONS

This application claims priority to Taiwanese Application Serial Number 103103615, filed Jan. 29, 2014, which is herein incorporated by reference.

### BACKGROUND

1. Field of Invention

The invention relates to a packaging film for a battery and a method for manufacturing the same, and more particularly to a packaging film for a battery including a fluorine resin layer and a method for manufacturing the same.

2. Description of Related Art

The development of a lithium ion secondary battery mainly trends to high volumetric energy density. The lithium ion secondary battery is used as a power supply for portable electronic products, smart phones, electric vehicles and the like. In recent years, because of the miniaturization and thinning tendency of the portable electronic products, a packaging material for the lithium ion battery or a lithium polymer battery should have the properties of lightweight, thin and high barrier and be able to use in batteries with different sizes and thickness. Accordingly, the traditional metal can package for packaging the battery was replaced by 10 to 100 μm of an aluminum foil sandwiched by plastic thin films to reach the demand of lightweight.

Being a part of the battery, the packaging material will affect the efficiency of the battery, thus, the packaging material for the battery should meet the requirement of particular physical properties.

The lithium battery is very sensitive to temperature, especially such as the raising temperature when charging and discharging the batteries, the change of the environment temperature when using the batteries. Therefore, the stability and sealing property of packaging material for the lithium battery should be ensured and should have good heat-sealing property.

Some organic substances of the packaging material may be dissolved in the electrolyte and a chemical reaction will occur thereby, which will result in deteriorating the performance of the battery. Therefore, after packaging by the packaging material, the electrolyte leakage is not allowed during long-term storage and operation. The packaging material cannot be dissolved or swelled in the electrolyte. Therefore, the packaging material should have excellent electrolyte resistance ability to be soaked in the electrolyte.

When the sealing part of the battery is infiltrated by external moisture, the electrolyte will hydrolyze and produce acid and heat, which may corrode the packaging material or cause battery fire. In addition, due to the raise of temperature, the battery power may decrease and cause the connected machine stop or failure. Therefore, the packaging material for the battery should meet the requirement of preventing moisture. The performance of battery can be maintained by the moisture resistance of the packaging material. In other words, the moisture resistance of the packaging material will seriously affect the battery.

To consider the required properties, workability and manufacturing cost of the battery, the traditional packaging film for the battery is constituted by nylon layer, adhesive layer, aluminum foil layer, adhesive layer and sealant layer in sequence. The aluminum foil layer is used as an intermediate layer to prevent moisture. The nylon layer and the sealant layer are used for heat-sealing and providing the strength. However, the aluminum foil layer is not sufficiently protected by the nylon layer because the nylon layer is easily cracked in high temperature and humid environment. Thus, the exposed aluminum foil layer will be corroded by acid and salt from external environment, and accordingly, risks of electrolyte leakage and battery damage may occur. In addition, the adhesive layer for adhering the nylon layer to aluminum foil layer commonly used in prior art comprises polyurethane adhesive and aromatic curing agent, which will occur yellowing phenomenon and hydrolysis in high temperature and humid environment to result in the nylon layer peeling and adhesive layer deteriorating, the aluminum foil layer thus is corroded thereby.

In view of the foregoing, there is still a need for a novel packaging film for the battery to surmount the aforesaid disadvantages of the prior art.

### SUMMARY

The present invention is directed to a packaging film for a battery and a method for manufacturing the same. The packaging film for the battery has excellent weatherability and thinner thickness.

According to an aspect of the present invention, a packaging film for the battery is provided. In an embodiment of the present invention, the packaging film for the battery includes an aluminum foil layer; a fluorine resin layer disposed on a surface of the aluminum foil layer; an adhesive layer disposed on another surface of the aluminum foil layer opposite to the fluorine resin layer; and a polyolefin sealant layer attached on the aluminum foil layer by the adhesive layer.

In an embodiment of the present invention, a material of the fluorine resin layer is selected from the group consisting of polytetrafluoroethylene, polyvinylidene fluoride, tetrafluoroethylene-perfluoroalkyl monomer copolymer and tetrafluoroethylene-vinyl monomer copolymer.

In an embodiment of the present invention, a thickness of the fluorine resin layer is in a range of 10 μm to 25 μm.

In an embodiment of the present invention, a cohesive strength between the aluminum foil layer and the fluorine resin layer is greater than 5B tested by cross hatch test.

In an embodiment of the present invention, the surface of the aluminum foil layer is treated by a surface treatment.

In an embodiment of the present invention, the surface of the aluminum foil layer is treated to have hydroxyl (OH) group.

In an embodiment of the present invention, a material of the adhesive layer is selected from the group consisting of polyolefin resin, polyester resin, polyether resin, epoxy resin and a combination thereof.

In an embodiment of the present invention, the polyolefin sealant layer is a cast polypropylene (CPP) film.

According to another aspect of the present invention, a method for manufacturing a packaging film for a battery is provided.

In an embodiment of the method of the present invention, the method for manufacturing the packaging film for the battery includes the steps of: providing an aluminum foil layer; processing a surface of the aluminum foil layer by a surface treatment; coating a fluorine resin layer on the surface of the aluminum foil layer treated by the surface treatment; coating an adhesive layer on another surface of the aluminum foil layer opposite to the fluorine resin layer; and adhering a polyolefin sealant layer on the aluminum foil layer by the adhesive layer.

In an embodiment of the method of the present invention, the surface treatment is processed by an acid degreaser agent, a titanium salt treatment agent or a combination thereof.

In an embodiment of the method of the present invention, the method for manufacturing the packaging film for the battery further includes the step of: coating a modified polyproylene primer on another surface of the aluminum foil layer opposite to the fluorine resin layer before coating the adhesive layer.

The forgoing presents a simplified summary of the disclosure in order to provide a basic understanding of the present invention. This summary is not an extensive overview of the disclosure and it does not identify key/critical elements of the present invention or delineate the scope of the present invention. Its sole purpose is to present concepts disclosed herein in a simplified form as a prelude to the more detailed description that is presented later.

Many of the attendant features will be more readily appreciated as the same becomes better understood by reference to the following detailed description considered in connection with the accompanying drawings. It is noteworthy that the drawings shown in the figures are for illustrative purposes only and not to scale.

### BRIEF DESCRIPTION OF THE DRAWINGS

The invention can be more fully understood by reading the following detailed description of the embodiment, with reference made to the accompanying drawings as follows:

FIG. 1 is a cross-sectional view of a packaging film for a battery according to an embodiment of the present invention; and

FIGS. 2A to 2E illustrate cross-sectional views of the steps in a method for manufacturing a packaging film for a battery of an embodiment of the present invention.

### DETAILED DESCRIPTION

Accordingly, a packaging film for a battery and a method for manufacturing the same are provided. In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

According to an aspect of the present invention, a packaging film for the battery is provided.

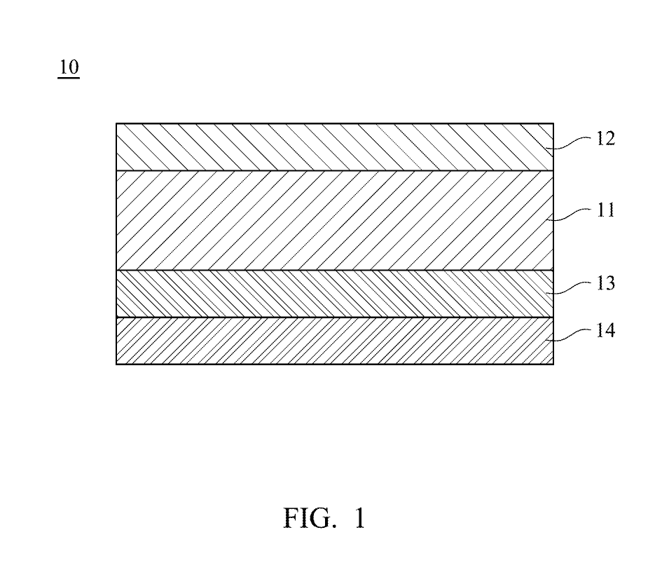

FIG. 1 is a cross-sectional view of a packaging film for the battery 10 according to an embodiment of the present invention. The packaging film for the battery 10 has advantages of better weatherability, saving materials of an adhesive layer and thinning overall thickness. The packaging film for the battery 10 shown in FIG. 1 includes an aluminum foil layer 11, a fluorine resin layer 12, an adhesive layer 13 and a polyolefin sealant layer 14. The fluorine resin layer 12 is disposed on a surface of the aluminum foil layer 11. The adhesive layer 13 is disposed on another surface of the aluminum foil layer 11 opposite to the fluorine resin layer 12. The polyolefin sealant layer 14 is attached on the aluminum foil layer 11 by the adhesive layer 13.

The aluminum foil layer 11 is used to prevent the penetration of moisture and oxygen into the battery. The material of the aluminum foil layer 11 can be a pure aluminum foil or an aluminum foil having a small amount of iron to improve the workability. To consider the workability and barrier property to prevent the penetration of moisture and oxygen into the battery, a thickness of the aluminum foil layer 11 is commonly in a range of 10 μm to 100 μm. If the aluminum foil layer 11 has a thinner thickness, the aluminum foil may easily crack or have pinhole formed during processing process and a risk of moisture and oxygen penetrating will increase therefore. In contrast, if the aluminum foil layer 11 has a thicker thickness, the overall thickness and weight of the packaging film will be increased, thus, the volumetric energy density will be decreased. In an embodiment of the present invention, the material of aluminum foil layer 11 is a soft aluminum foil having iron content of 2%. The aluminum foil layer 11 has a thickness of about 40 μm.

The fluorine resin layer 12 provides the excellent properties of heat resistance, moldability, insulation and electrolyte resistance ability to the packaging film for the battery 10. The packaging film for the battery 10 can have better weatherability in high temperature and humid environment because the fluorine resin layer 12 has higher thermal degradation than the nylon layer used in known packaging film for the battery. In addition, the fluorine resin layer 12 has better electrolyte resistance, which can avoid electrolyte leakage and battery damage due to inappropriate battery packaging process.

The material of the fluorine resin layer 12 can be fluorine resin, such as polytetrafluoroethylene, polyvinylidene fluoride, tetrafluoroethylene-perfluoroalkyl monomer copolymer and tetrafluoroethylene-vinyl monomer copolymer. In a preferred embodiment of the present invention, the material of fluorine resin layer 12 is tetrafluoroethylene-vinyl monomer copolymer. The thickness of the fluorine resin layer 12 can be in a range of 10 μm to 25 μm. In an embodiment of the present invention, the thickness of the fluorine resin layer 12 is about 15 μm.

Cross hatch test method is a common adhesion testing method, which is available to determine the adhesion strength of a coating bonded to a solid substrate. The cross hatch test includes the steps of: providing a test sample of a coating and a substrate, the sample cutting to 10×10 (100) of 1mm×1 mm lattice patterns by a cross-hatch cutter, wherein each of cutting lines cuts into the finish coating down to the substrate; diagonally brushing the test area to remove any loose particles; applying a special tape, such as 3M 600 or the like, for testing adhesion over the cross hatch test area, and then wiping the tape by eraser to increase the adhesion strength between the tape and the test area; removing the tape quickly in vertical direction by pulling the tape back off of the test area and repeating the above steps in the same area. In the standard list, there are six classes from 5B-0B with visual diagrams of varying degrees of coating pull-off. Class 5B represents that the edges of the cuts are completely smooth and none of the lattice is detached. Class 4B represents that small flakes of the coating at the intersections detached of the cuts and a cross cut area, and the total area of the flakes is not greater than 5% of the total test area. Class 3B represents that the coating has flaked along the edges and at the intersections of the cuts, and the total area of the flakes is in a range of 5% to 15%. Class 2B represents that the coating has flaked along the edges of the cuts partly or wholly in large ribbons, or it has flaked partly or wholly on different parts at the intersections of the cuts, and the total area of the flakes is in a range of 15% to 35%. Class 1B represents that the coating has flaked along the edges of the cuts partly or wholly in large ribbons, and it has flaked partly or wholly on different parts at the intersections of the cuts, and the total area of the flakes is in a range of 35% to 65%. Class 0B represents that the coating has flaked along the edges of the cuts in large ribbons and some intersections of the cuts have detached partly or wholly, and the total area of the flakes is greater than 65%. The fluorine resin layer 12 is coated on the aluminum foil layer 11 and a cohesive strength between the aluminum foil layer 11 and the fluorine resin layer 12 is greater than 5B tested by cross hatch test.

The fluorine resin layer 12 is coated to the aluminum foil layer 11 directly on the surface of aluminum foil layer 11 without using any adhesive. Therefore, a risk of aluminum foil layer 11 corrosion caused by interface delamination or adhesive layer deterioration or the like can be avoided. In addition, the overall thickness of the packaging film for the battery can be decreased due to the elimination of the adhesive layer and nylon layer.

In another embodiment of the present invention, the surface of aluminum foil layer 11 is treated by a surface treatment before coating the fluorine resin layer 12. The surface treatment makes the aluminum foil layer 11 and the fluorine resin layer 12 connected tightly, and the coating process can be processed easily. In an embodiment of the present invention, the surface of the aluminum foil layer 11 is treated by the surface treatment to have hydroxyl (OH) groups which are resulted from a chemical coating formed by the surface treatment processed with an acid degreaser and a titanium salt treatment agent.

The adhesive layer 13 is disposed on another surface of the aluminum foil layer 11 opposite to the fluorine resin layer 12, as shown in FIG. 1. The material of the adhesive layer 13 can be but not limited to polyolefin resin, polyester resin, polyether resin, epoxy resin and a combination thereof. The thickness of the adhesive layer 13 is commonly in a range of 3 μm to 8 μm. In an embodiment of the present invention, the material of the adhesive layer 13 is polyolefin resin and a thickness of the adhesive layer 13 is about 5 μm.

The polyolefin sealant layer 14 is attached on the aluminum foil layer 11 by the adhesive layer 13. The polyolefin sealant layer 14 can be a single-layer resin thin film or multi-layer resin thin film, such as a polypropylene film, polyethylene film, modified polypropylene film or cast polypropylene (CPP) film. The polyolefin sealant layer 14 provides, by heat-sealed, the electrolyte resistance of highly corrosive electrolyte, suitable heat-sealing strength and moistureproof to protect the properties of electrolyte. In an embodiment of the present invention, to consider the properties of heat-sealing and workability, the polyolefin sealant layer 14 is a three-layer cast polypropylene (CPP) film. The cast polypropylene film is commonly an adhesive layer/intermediate layer/heat sealing layer structure sequentially. The cast polypropylene film can be formed by three-layer co-extruded or co-blowing processes. The adhesive layer of CPP film is for enhancing the adhesion and can be a polypropylene random copolymer (PP-R) film with better stampability. The intermediate layer of the CPP film is configured for supporting and can be a polypropylene homopolymer (PP-H) film with good rigidity. The heat sealing layer of the CPP film can be the polypropylene random copolymer (PP-R) film with good heat-sealing property and stampability. However, the embodiments of adhesive layer, intermediate layer and heat sealing layer are not limited thereto.

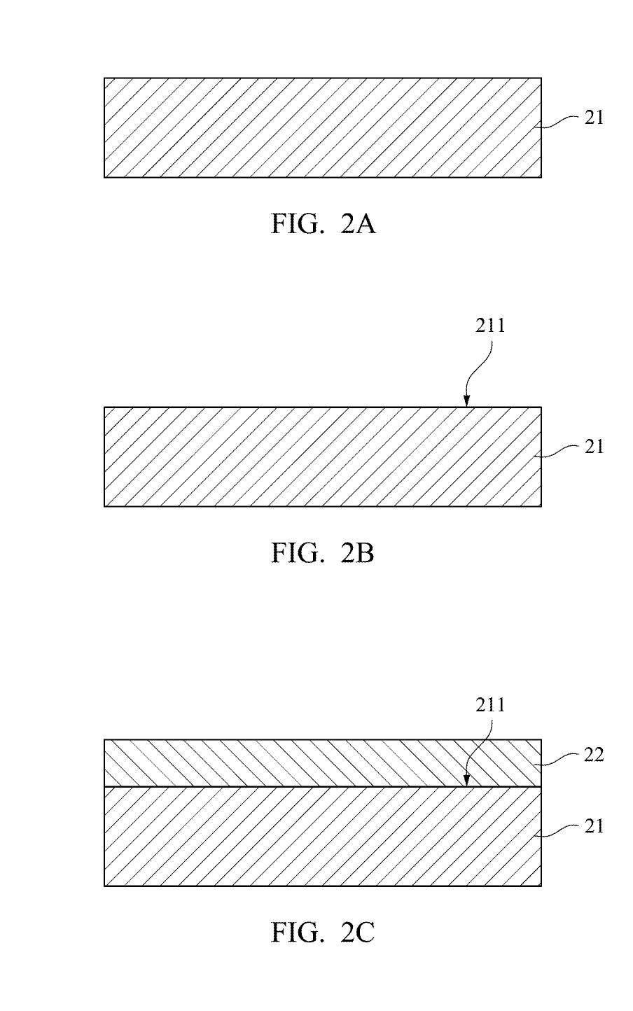

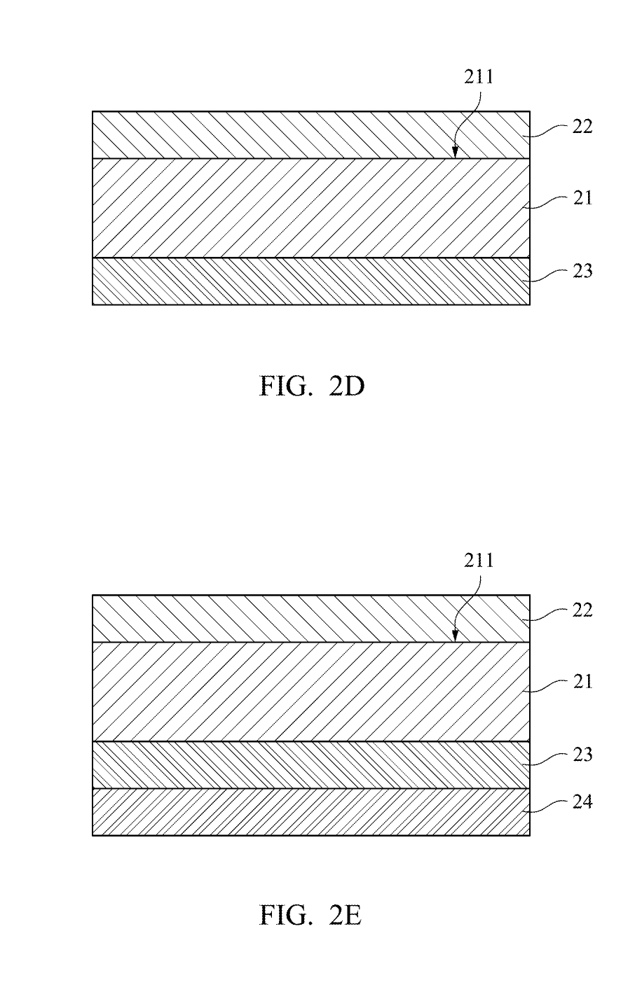

According to another aspect of the present invention, a method for manufacturing a packaging film for a battery is provided. FIGS. 2A to 2E illustrate the steps in a method for manufacturing a packaging film for the battery of an embodiment of the present invention.

Firstly, an aluminum foil layer 21 is provided, as shown in FIG. 2A. The aluminum foil layer 21 is used to prevent the penetration of moisture and oxygen into the battery. The material of aluminum foil layer 21 can be a pure aluminum foil or an aluminum foil having a small amount of iron to improve the workability. A thickness of the aluminum foil layer 21 is commonly in a range of 10 μm to 100 μm. To consider the physical properties, the material of aluminum foil layer 11 is a soft aluminum foil having iron content of 2% and the aluminum foil layer 11 has a thickness of about 40 μm in an embodiment of the method of the present invention.

Then, the aluminum foil layer 21 is processed by a surface treatment selectively for one surface or both surfaces, as shown in FIG. 2B. The surface treatment is advantaged for the aluminum foil layer 21 and the fluorine resin layer 22 coated later connected tightly, and the coating process can be processed easily. In an embodiment of the method of the present invention, the surface 211 of the aluminum foil layer 21 is soaked into an acid degreaser and a titanium salt treatment agent to form a chemical coating (not shown) on the surface 211 of the aluminum foil layer 21. After the surface treatment, the surface 211 of the aluminum foil layer 21 has hydroxyl (OH) groups to make the coating process to be easily processed later.

A fluorine resin layer 22 is coated on the surface 211 of the aluminum foil layer 21 treated by the surface treatment, as shown in FIG. 2C. The fluorine resin layer 22 provides excellent properties of heat resistance, moldability, insulation and electrolyte resistance ability to the packaging film for the battery. The packaging film for the battery can have better weatherability in high temperature and humid environment because the fluorine resin layer 22 has higher thermal degradation than the nylon layer used in a traditional packaging film for the battery. In addition, the fluorine resin layer 22 has better electrolyte resistance, which can avoid electrolyte leakage and battery damage due to inappropriate battery packaging process. In another embodiment of the method of the present invention, the fluorine resin layer 22 is coated on a surface 211 of the aluminum foil layer 21 directly, and the surface 211 is not treated with a surface treatment.

The material of fluorine resin layer 22 can be fluorine resin, such as polytetrafluoroethylene, polyvinylidene fluoride, tetrafluoroethylene-perfluoroalkyl monomer copolymer and tetrafluoroethylene-vinyl monomer copolymer. In a preferred embodiment of the method of the present invention, the material of fluorine resin layer 22 is tetrafluoroethylene-vinyl monomer copolymer. The thickness of the fluorine resin layer 22 can be in a range of 10 μm to 25 μm. In an embodiment of the method of the present invention, the thickness of the fluorine resin layer 22 is about 15 μm, as shown in FIG. 2C. A cohesive strength between the aluminum foil layer 21 and the fluorine resin layer 22 is greater than 5B tested by cross hatch test.

After forming the fluorine resin layer 22, an adhesive layer 23 is coated on another surface of the aluminum foil layer 21 opposite to the fluorine resin layer 22, as shown in FIG. 2D. In another embodiment of the method of the present invention, before coating the adhesive layer 23, a modified polyproylene primer is coated on another surface of the aluminum foil layer 21 opposite to the fluorine resin layer 22 selectively, and then, the adhesive layer 23 is coated on the primer. The material of the adhesive layer 23 can be but not limited to polyolefin resin, polyester resin, polyether resin, epoxy resin and a combination thereof. The thickness of the adhesive layer 23 is commonly in a range of 3 μm to 8 μm. In an embodiment of the method of the present invention, the material of the adhesive layer 23 is polyolefin resin and a thickness of the adhesive layer 23 is about 5 μm.

Finally, a polyolefin sealant layer 24 is adhered on the aluminum foil layer 21 by the adhesive layer 23, as shown in FIG. 2E. The polyolefin sealant layer 24 can be a single-layer resin thin film or multi-layer resin thin film, such as a polypropylene film, polyethylene film, modified polypropylene film or cast polypropylene (CPP) film. The polyolefin sealant layer 24 provides, by heat-sealed, the electrolyte resistance of highly corrosive electrolyte, suitable heat-sealing strength and moistureproof to protect the properties of electrolyte. In an embodiment of the method of the present invention, for the properties of heat-sealing and workability, the polyolefin sealant layer 24 is a three-layer cast polypropylene (CPP) film. The cast polypropylene film is commonly an adhesive layer/intermediate layer/heat sealing layer structure sequentially. The cast polypropylene film can be formed by three-layer co-extruded or co-blowing processes. The adhesive layer of the CPP film is for enhancing the adhesion and can be a polypropylene random copolymer (PP-R) film with better stampability. The intermediate layer of the CPP film is for supporting and can be a polypropylene homopolymer (PP-H) film with good rigidity. The heat sealing layer of the CPP film can be a polypropylene random copolymer (PP-R) film with good heat-sealing property and stampability. However, the embodiments of the adhesive layer, intermediate layer and heat sealing layer are not limited thereto.

Accordingly, the packaging film for the battery manufactured by the method of the present invention has thinner thickness and better weatherability to avoid adhesive layer for adhering the nylon layer to the aluminum foil layer occurring yellowing phenomenon and hydrolysis to result in the nylon layer peeling and the aluminum foil layer corroding. In addition, the packaging film for the battery can have better weatherability in high temperature and humid environment because the fluorine resin layer has higher thermal degradation.

The present invention will be explained in further detail with reference to the examples. However, the present invention is not limited to these examples.

### EXAMPLE

### Example 1

### Preparation of Packaging Film for Battery

A soft aluminum-iron based alloy aluminum foil (JIS 8079) having no visible pinhole on the surface and having a thickness of 40 μm was prepared. Firstly, the aluminum foil was washed by water and then soaked in 2% acid degreaser solution for 2 minutes. After washing, the aluminum foil was soaked in 1.5% titanium salt treatment agent (available from Potencer Chemical, Taiwan) for 2 minutes, and then a heat treatment was conducted to the aluminum foil to form a chemical coating layer. Then, tetrafluoroethylene-vinyl monomer copolymer GK570 (available from Daikin Industries, Japan) and curing agent N3300 (available from Bayer, Germany) were coated on the chemical coating layer and a heat treatment was conducted in an oven for 2 minutes. A thickness of the tetrafluoroethylene resin layer was about 15 μm.

Then, a modified polyproylene primer P-4 (available from Great eastern resins, Taiwan) was coated on another surface of the aluminum foil and conducted a heat treatment in an oven at 120° C. for 1.5 minutes. The thickness of the primer layer is about 1.5 μm. After drying the primer, polyolefin adhesive LIS405-A5 and curing agent LCR-032 (available from Toyo morton, Japan) were coated on the primer and conducted a heat treatment in an oven at 120° C. for 1.5 minutes. The thickness of the adhesive layer is about 5 μm.

A cast polypropylene (CPP) film was treated by corona treatment and then adhered on the aluminum foil layer by the adhesive layer. Finally, the resulting product was stand at 60° C. for 7 days to crosslink and ripe the coating and adhesive layer respectively.

A commercially available battery packaging film having the structure of nylon layer/aluminum foil layer/polypropylene layer was prepared as Comparative Example 1. The results of physical property tests of Example 1 of the present invention and Comparative Example 1 were shown as the following Table 1. The weatherability test condition of the battery packaging are as following: temperature at 121° C., relative humidity at 100% and 2 atm, after standing for 168 hours, the appearance of the battery packaging films were observed.

TABLE 1
The result of physical property tests

| | Example 1 | Comparative Example 1 |
|---|---|---|
| Thickness (μm) | 100 | 118 |
| Moisture permeability | 17 | 25 |
| (g/m² * day) | | |
| Heating sealing strength | 60.7 | 61.1 |
| (N/cm) | | |
| Weatherability | Complete | Nylon layer has peeled |

After the weatherability test, the adhesive layer for adhering nylon of Comparative Example 1 had yellowing phenomenon and hydrolysis and the nylon layer had peeled. In contrast, the packaging film for the battery of Example 1 still maintained appearance completely.

A cohesive strength between the aluminum foil layer and the fluorine resin layer of Example 1 was greater than 5B tested by cross hatch test. The fluorine resin layer was completely adhered on the aluminum foil layer.

A stamping test was further conducted on Example 1. The packaging film for the battery of Example 1 was stamped into a product with thickness of 4 mm and stood in an oven at 60° C. for 30 days. After the test, cracking or peeling phenomenon did not occur on the curved surfaces or corners of the product.

As shown in the result of physical property tests, the moisture permeability of Example 1 is lower than Comparative Example 1, and the weatherability of Example 1 is better than Comparative Example 1. Both heating sealing strength of Example 1 and Comparative Example 1 are similar. From the forgoing, the packaging film for the battery according to the present invention has lower moisture permeability, excellent weatherability and thinner thickness, and can be used as flexible outer package of battery to resist high temperature, high humidity and high pressure environment for protecting the battery.

While the invention has been described by way of example(s) and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A packaging film for a battery, comprising:
an aluminum foil layer;
a fluorine resin layer disposed on a surface of the aluminum foil layer;
an adhesive layer disposed on another surface of the aluminum foil layer opposite to the fluorine resin layer; and
a polyolefin sealant layer attached on the aluminum foil layer by the adhesive layer.

2. The packaging film for the battery according to claim 1, wherein a material of the fluorine resin layer is selected from the group consisting of polytetrafluoroethylene, polyvinylidene fluoride, tetrafluoroethylene-perfluoroalkyl monomer copolymer and tetrafluoroethylene-vinyl monomer copolymer.

3. The packaging film for the battery according to claim 1, wherein a thickness of the fluorine resin layer is in a range of 10 μm to 25 μm.

4. The packaging film for the battery according to claim 1, wherein a cohesive strength between the aluminum foil layer and the fluorine resin layer is greater than 5B tested by cross hatch test.

5. The packaging film for the battery according to claim 1, wherein the surface of the aluminum foil layer is treated by a surface treatment.

6. The packaging film for the battery according to claim 5, wherein the surface of the aluminum foil layer is surface treated to having hydroxyl (OH) groups.

7. The packaging film for the battery according to claim 1, wherein a material of the adhesive layer is selected from the group consisting of polyolefin resin, polyester resin, polyether resin, epoxy resin and a combination thereof.

8. The packaging film for the battery according to claim 1, wherein the polyolefin sealant layer is a cast polypropylene (CPP) film.

9. A method of manufacturing a packaging film for a battery, comprising the steps of:
providing an aluminum foil layer;
processing a surface of the aluminum foil layer by a surface treatment;
coating a fluorine resin layer on the surface of the aluminum foil layer treated by the surface treatment;
coating an adhesive layer on another surface of the aluminum foil layer opposite to the fluorine resin layer; and
adhering a polyolefin sealant layer on the aluminum foil layer by the adhesive layer.

10. The method according to claim 9, wherein the surface treatment is processed by an acid degreaser agent, a titanium salt treatment agent or a combination thereof.

11. The method according to claim 9, further comprising coating a modified polyproylene primer on another surface of the aluminum foil layer opposite to the fluorine resin layer before coating the adhesive layer.
